(19) United States
(12) Patent Application Publication
(10) Pub. No.: US 2026/0085255 A1
(43) Pub. Date: Mar. 26, 2026

(54) LAUNDRY COMPOSITION

(71) Applicant: Conopco, Inc., d/b/a UNILEVER, Hoboken, NJ (US)

(72) Inventors: Yanchao CHEN, Shanghai (CN); Zhongwen CUI, Shanghai (CN); Minhua ZHANG, Shanghai (CN)

(73) Assignee: Conopco, Inc., d/b/a UNILEVER, Hoboken, NJ (US)

(21) Appl. No.: 19/109,393

(22) PCT Filed: Aug. 22, 2023
(86) PCT No.: PCT/EP2023/072954

§ 371 Date: Mar. 6, 2025

(30) Foreign Application Priority Data
Sep. 8, 2022 (WO) PCT/CN2022/117807
Oct. 21, 2022 (EP) 22203136.1

(51) Int. Cl. C11D 1/29; C11D 3/04; C11D 3/22; C11D 3/50; C11D 17/06

(52) U.S. Cl. CPC C11D 1/29; C11D 3/046; C11D 3/221; C11D 3/505; C11D 17/06; C11D 2111/12

(57) ABSTRACT

A laundry composition is disclosed comprising a plurality of particles, wherein the particle comprises from 20 to 95% by weight of a water-soluble carrier selected from a carbohydrate, an inorganic alkali metal salt, an organic alkali metal salt, an inorganic alkaline earth metal salt, an organic alkaline earth metal salt, a urea and mixtures thereof; from 5 to 15% by weight of an anionic surfactant selected from alkyl sulfate, alkyl ether sulfate, soap, and mixtures thereof; and from 0.1 to 30% by weight of benefit agents; wherein the water-soluble carrier comprises a carbohydrate selected from sugar, sugar alcohol, and mixtures thereof; and wherein the composition comprises less than 1.5% by weight of alkylbenzene sulfonates.

### FIELD OF THE INVENTION

The present invention relates to a laundry composition comprising a plurality of particles.

### BACKGROUND OF THE INVENTION

A wide variety of laundry products are available in the market, including detergents, fabric conditioners, stain removers and bleach. Laundry products are used for various reasons, traditionally detergents are used for cleaning and fabric conditioners are used for softening and perfuming fabrics. There is a continuing need for laundry products which provide fabric care benefits to fabrics.

Various benefit agents are commonly incorporated in laundry products to provide fabric care benefits. However, the addition of benefit agents to a laundry product has the drawbacks of increased complexity in formulations, increased cost and benefit agents which may not meet the environmental credentials desired by the consumer.

Nowadays, laundry products that provide additional benefits to their fabrics in addition to common laundry detergents and fabric conditioners are popular with consumers. Consumers enjoy products that enables them to use a custom amount of benefit agents based on their personal preferences of how much of the benefit agents is needed to provide the desired benefit. There is an increased demand for laundry products which allow the consumer to tailor their laundry process to suit their needs and preferences.

Products have been developed to provide benefits to fabrics during laundry, independent of other laundry products, to achieve the desired benefit based on consumers' personal preferences. Among such products, those in the form of particles are particularly popular. Conventional carrier materials for the particles are synthetic polymers like polyethylene glycol (PEG). In a typical production method of the particles, a melt comprising the carrier material and other constituents is first produced and the melt obtained is mixed directly with the benefit agents. The finished melt dispersion is then shaped into particles.

WO 2011/056938A1 relates to a laundry scent additive having polyethylene glycol and perfume. The laundry scent additive enables consumers to control the amount of scent imparted to their laundry.

WO 2016099852A1 relates a composition of a plurality of homogeneously structured particles. The particles include polyethylene glycol, perfume, and starch granules and each has a mass between about 0.95 mg and about 5 grams.

However, the production of such products has certain limitations: the production method including heating and cooling is time consuming and complicated which requires special equipment; some benefit agents such as fragrance tend to evaporate quickly at higher temperatures and therefore the fragrance content of the composition decreases rapidly during production. Furthermore, the carrier materials like PEG are expensive and not sustainable. Many consumers prefer compounds with a good environmental profile and there is therefore the need for alternatives to petroleum based raw materials for the purpose of environmental sustainability.

Another problem which can arise with laundry products in the form of particles is that the products may have poor stability. For example, the particles may stick together and lose its flowability during production, transportation and/or storage, which would give rise to processing problems and consumer dosing problems. Such particles may even leave more residues in the washing machine (e.g., on the washing machine door glass or the rubber ring) after washing due to the stickiness of the particles, resulting in poor user experience for consumers. Furthermore, the particles may be brittle and tended to break up into small pieces or irreversibly deform during production, transportation and/or storage, which can imply poor quality of the product and negatively impact consumer acceptance of the product.

Furthermore, the dissolution behavior of laundry products in the form of particles is also important to consumers.

Therefore, there remains a need to improve such laundry products.

### SUMMARY OF THE INVENTION

In a first aspect, the present invention is directed to a laundry composition comprising a plurality of particles, wherein the particle comprises:
a) from 20 to 95% by weight of a water-soluble carrier selected from a carbohydrate, an inorganic alkali metal salt, an organic alkali metal salt, an inorganic alkaline earth metal salt, an organic alkaline earth metal salt, a urea and mixtures thereof;
b) from 5 to 15% by weight of an anionic surfactant selected from alkyl sulfate, alkyl ether sulfate, soap, and mixtures thereof; and
c) from 0.1 to 30% by weight of benefit agents;
   wherein the water-soluble comprises a carbohydrate selected from sugar, sugar alcohol, and mixtures thereof; and
   wherein the composition comprises less than 1.5% by weight of alkylbenzene sulfonates.

In a second aspect, the present invention is directed to a method of forming the laundry composition of any embodiment of the first aspect comprising the steps of:
(i) combining constituent ingredients of the composition to form a mixture;
(ii) feeding the mixture to an extruder and extruding it to form an extrudate;
(iii) cutting the extrudate to form the particles;
(iv) drying the particles; and
(v) optionally dusting the particles with an anti-caking agent.

In a third aspect, the present invention is directed to a method of treating laundry comprising the steps of:
(i) providing fabrics in a washing machine;
(ii) dispensing the laundry composition of any embodiment of the first aspect into the washing machine; and
(iii) contacting the fabrics with the laundry composition during a wash sub-cycle of the washing machine.

In a fourth aspect, the present invention is directed to use of a laundry composition of any embodiment of the first aspect to provide fabric care benefits to laundered fabrics during the laundry process, preferably impart fragrance to laundered fabrics.

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

All amounts are by weight of the composition, unless otherwise specified.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

The laundry composition in the context of the present invention is a laundry composition intended for use in addition to a traditional detergent or fabric conditioner. The laundry composition provides an additional benefit over and above those delivered by a detergent or fabric conditioner and they provided the consumer with the ability to customize the levels of benefit agents delivered in the wash.

### Water-Soluble Carrier

The term “water-soluble” as used herein, means that a material is soluble or otherwise dispersible in water at a level of at least 90% by weight at 25° C. under ambient condition, preferably at least 95% by weight and more preferably at least 98% by weight at 25° C. under ambient condition. The particles of the present invention comprise no less than 20% by weight of a water-soluble carrier, preferably no less than 30%, more preferably no less than 35% and most preferably no less than 40% by weight of a water-soluble carrier. The particles of the present invention comprise no more than 95% by weight of water-soluble carrier, preferably no more than 85%, more preferably no more than 75% and most preferably no more than 70% by weight of a water-soluble carrier. The particle of the present invention comprises from 20 to 95% by weight of a water-soluble carrier, preferably from 30 to 85%, more preferably from 35 to 75% and most preferably from 40 to 70% by weight of a water-soluble carrier.

The water-soluble carrier is selected from a carbohydrate, an inorganic alkali metal salt, an organic alkali metal salt, an inorganic alkaline earth metal salt, an organic alkaline earth metal salt, a urea and mixtures thereof.

Suitable alkali metal salt comprises an alkali metal ion selected from lithium, sodium, potassium and mixtures thereof, and an anion selected from fluoride, chloride, bromide, iodide, sulfate, bisulfate, phosphate, carbonate, acetate, citrate, lactate, pyruvate, ascorbate, sorbate and mixtures thereof. Examples of suitable inorganic alkali metal salts include, but not limited to, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate or mixtures thereof. Examples of suitable organic alkali metal salts include sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate or mixtures thereof.

Suitable alkaline earth metal salt comprises an alkali earth metal ion selected from magnesium, calcium and mixtures thereof, and an anion selected from fluoride, chloride, bromide, iodide, sulfate, bisulfate, phosphate, carbonate, acetate, citrate, lactate, pyruvate, ascorbate, sorbate and mixtures thereof. Examples of suitable inorganic alkaline earth metal salts include, but not limited to, magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate or mixtures thereof. Examples of suitable organic alkaline earth metal salts include magnesium acetate, magnesium citrate, magnesium lactate, magnesium tartrate, magnesium ascorbate, magnesium sorbate, calcium acetate, calcium citrate, calcium lactate, calcium tartrate, calcium ascorbate, calcium sorbate or mixtures thereof.

The water-soluble carrier comprises a carbohydrate selected from sugar, sugar alcohol and mixtures thereof, which may reduce the corrosion of the internal parts of the washing machine compared with using salts as the carrier. More preferably the water-soluble carrier comprises sugar. Suitable sugar may be selected from dextrose, sucrose, fructose, glucose, isoglucose, rhamnose, fucose, deoxyribose, ribose, trehalose, xylose, mannose, arabinose, galactose, cellobiose, lactose, maltose, isomaltose, melibiose, gentobiose, maltotriose, raffinose, panose, and mixtures thereof. Preferably the sugar is selected from dextrose, sucrose, fructose, glucose, isoglucose, galactose, raffinose, and mixtures thereof. More preferably the sugar comprises or is sucrose.

A sugar alcohol is an organic compound having more than two hydroxyl groups. The sugar alcohol can have from 4 to 12 carbon atoms. Suitable sugar alcohol may be selected from sorbitol, mannitol, isomalt, maltitol, lactitol, xylitol, erythritol, and mixtures thereof. Preferably the sugar alcohol is selected from mannitol, sorbitol and mixtures thereof.

It may be preferable to include a bittering agent if the water-soluble carrier comprises sugar. Preferred bettering agent is selected from the group consisting of denatonium benzoate, denatonium saccharide, quinine or a salt of quinine. The chemical name of denatonium is phenylmethyl-[2-[(2,6-dimethylphenyl)amino]-2-oxoethyl]-diethylammonium. Denatonium benzoate is particularly preferred. An example is Bitrex® from Johnson Matthey Fine Chemicals. Preferably the bittering agent is present in an amount from 0.001 to 0.01% by weight of the particles.

The particles of the present invention may comprise an additional carrier (in addition to the water-soluble carrier). The additional carrier material may provide various benefits such as stability benefits. The additional carrier materials may be selected from the group consisting of polymers (e.g, polyethylene glycol, ethylene oxide/propylene oxide block copolymers, polyvinyl alcohol, polyvinyl acetate, and derivatives thereof), proteins (e.g., gelatin, albumin, casein), polysaccharides (e.g., starch, xanthan gum, cellulose, or derivatives thereof), water dispersible fillers (e. g., zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and mixtures thereof.

Preferably the additional carrier comprises polysaccharide. A polysaccharide is a saccharide polymer comprising more than 10 monosaccharides units, preferably 15 to 1000 monosaccharides units and more preferably 25 to 500 monosaccharides units. Suitable polysaccharides may be selected from starch, glycogen, chitin, gum Arabic, xanthan gum, cellulose, callose, dextran, tunicin, inulin, alginic acid, gellan, guar, carob flour, carrageenan, and derivatives of these compounds, and mixtures thereof. Preferably the polysaccharide comprises starch and/or its derivatives. Most preferably the polysaccharide comprises or is starch. Suitable starch may be selected from wheat starch, rice starch, potato starch, corn starch, tapioca starch and mixtures thereof.

Preferably the particles of the present invention comprise from 0.1 to 50% by weight of the additional carrier, more preferably from 1 to 35%, even more preferably from 2 to 25%, and most preferably from 5 to 20% by weight of the additional carrier.

### Anionic Surfactant

The particles of the present invention comprise no less than 5% by weight of an anionic surfactant, preferably no less than 6% by weight of an anionic surfactant, more preferably no less than 7% by weight of an anionic surfactant. The particles of the present invention comprise no more than 15% by weight of an anionic surfactant, preferably no more than 12% by weight of an anionic surfactant, more preferably no more than 10% by weight of an anionic surfactant. The particles of the present invention comprise from 5 to 15% by weight of an anionic surfactant, preferably from 6 to 12% by weight of an anionic surfactant, more preferably from 7 to 10% by weight of an anionic surfactant.

The anionic surfactant may serve as binder to bind the carrier material and other constituent ingredients of the composition together thereby helping to provide for a processable composition in production. The use of 5 to 15% by weight of an anionic surfactant was surprisingly found to provide improved processability of the composition. The anionic surfactant may also improve the appearance of the particles and make the surface of the particles look smoother. Consumers are sensitive to visual cues when using a laundry product. A laundry product containing particles with rough surfaces are often regarded as quality problems and not liked by consumers.

The anionic surfactant is selected from alkyl sulfate, alkyl ether sulfate, soap and mixtures thereof. Preferably the anionic surfactant is selected from alkyl sulfate, alkyl ether sulfate and mixtures thereof. More preferably the anionic surfactant comprises or is alkyl sulfate.

Alkyl sulfates are anionic surfactants which are water soluble salts containing a hydrocarbon hydrophobic group and a hydrophilic sulfate group. Preferably, the alkyl sulfate has an alkyl group having 8 to 18 carbon atoms, more preferably from 10 to 18 carbon atoms, even more preferably from 10 to 16 carbon atoms. It will be appreciated that both branched and linear alkyl groups are encompassed. The alkyl group is preferably linear, i.e. normal alkyl, however, branched chain alkyl sulfates can be employed, although they are less preferred from a biodegradability perspective.

Preferably, the alkyl sulfate comprises a salt of an alkyl sulfate. In this way, the alkyl sulfate comprises a positively charged ion and a negatively alkyl sulfate moiety. The positively charged ion may be a metal ion such as sodium, potassium or magnesium; or an ammoniacal ion such as ammonium, monoethanolamine, diethanolamine or triethanolamine. Mixtures of such ions may also be employed. Sodium and potassium are preferred.

It is preferred that the alkyl sulfate comprises sodium, potassium, calcium, magnesium, ammonium or ethanolamine salts of alkyl sulfate having 8 to 18 carbon atoms, more preferably 10 to 18 carbon atoms, even more preferably from 10 to 16 carbon atoms. Illustrative yet non-limiting examples of alkyl sulfates include sodium lauryl sulfate (also known as sodium dodecyl sulfate), ammonium lauryl sulfate, diethanolamine (DEA) lauryl sulfate. Suitable examples also include alkyl sulfates commercially available from natural source with trade names Galaxy 689, Galaxy 780, Galaxy 789, Galaxy 799 SP, and Ufarol TCL 92N and from synthetic origin with trade names Safol 23, Dobanol 23A or 23S, Lial 123 S, Alfol 1412S, Empicol LC3, Empicol 075SR.

Sodium lauryl sulfate (SLS), also known as sodium dodecyl sulfate, is particularly preferred as the alkyl sulfate. An example of sodium lauryl sulfate is commercially available from Dongming Jujin Chemical Co., Ltd.

Alkyl ether sulfate is an anionic surfactant having a formula RO(CH₂CH₂O)ₙSO₃M, wherein R is a linear or branched, alkyl or alkenyl group having 8 to 18 carbon atoms, preferably 10 to 18 carbon atoms, more preferably 12 to 14 carbon atoms; M is a positively charged ion comprising sodium, potassium, calcium, magnesium, ammonium, monoethanolamine, diethanolamine, triethanolamine or mixtures thereof, preferably sodium, potassium or mixtures thereof; n is the degree of ethoxylation of from 0.5 to 3, preferably from 1 to 3. A preferred example is sodium lauryl ether sulfate (SLES) in which the predominantly C₁₂ lauryl alkyl group has been ethoxylated with an average of 2EO units per molecule.

The term “soap” as used herein, means the alkali metal or alkanol ammonium salts of aliphatic, alkanes, or alkene monocarboxylic acids. Preferred monocarboxylic acids are fatty acids with 6 to 22 carbon atoms, more preferably from 12 to 18 carbon atoms. Examples of suitable soap include, but not limited to, sodium, potassium, calcium, magnesium, ammonium, monoethanolamine, diethanolamine, triethanolamine salts of lauric acid, myristic acid, palmitic acid, stearic acid, (hydrogenated) erucic acid, behenic acid, coconut oil fatty acid, palm oil fatty acid, palm kernel oil fatty acid, olive oil fatty acid, tallow fatty acid or mixtures thereof. The fatty acids may be saturated or unsaturated, linear or branched. It is particularly preferred that the soap comprises sodium or potassium salts of coconut fatty acid, palm kernel oil fatty acid or mixtures thereof.

The particles of the present invention may comprise other anionic surfactants in addition to the anionic surfactants described above. Examples of suitable anionic surfactants include, but not limited to, alkyl sulfonates, alkaryl sulfonates, alpha-olefin sulfonates, alkyl isethionates, alkanoyl isethionates, alkyl succinates, alkyl sulphosuccinates, alkyl ether sulphosuccinates, N-alkyl sarcosinates, alkyl phosphates, alkyl ether phosphates, alkyl ether carboxylic acids and salts thereof, especially their sodium, potassium, calcium, magnesium, ammonium and mono-, di-, and triethanolamine salts. The alkyl radicals preferably contain from 10 to 18 carbon atoms and may be unsaturated. The alkyl ether sulphosuccinates, alkyl ether phosphates and alkyl ether carboxylic acids and salts thereof may contain from one to twenty ethylene oxide or propylene oxide units per molecule.

The particles of the present invention may comprise alkylbenezene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ. Examples of alkylbenzene sulfonates include sodium salt of linear alkylbenzene sulphonate, alkyl toluene sulphonate, alkyl xylene sulphonate, alkyl phenol sulphonate, alkyl naphthalene-sulphonate, ammonium diamylnaphthalene-sulphonate and sodium dinonylnaphthalene-sulphonate and mixtures with olefin sulphonates. The particles of the present invention are substantially free of alkylbenezene sulfonates. “Substantially free of”, as used herein, means less than 1.5%, preferably less than 1.0%, more preferably less than 0.75%, more preferably still less than 0.5% and even more preferably less than 0.1% and most preferably from 0 to 0.01% by weight, based on total weight of the composition, including all ranges subsumed therein. It is preferred that the particles of the present invention do not comprise any alkylbenezene sulfonates.

### Benefit Agents

Benefit agent as used herein means an active typically delivered to laundered fabrics to enhance or improve a characteristic of those fabrics. Preferably, the benefit agents are dispersed within the carrier materials. The benefit agents may be free in the carrier material or they may be encapsulated. The particles of the present invention comprise from 0.1 to 30% by weight of the benefit agents, preferably from 1 to 30%, more preferably from 2 to 30%, even more preferably from 5 to 30%, even more preferably from 5 to 20%, and most preferably from 5 to 15% by weight of the benefit agents.

Examples of suitable benefit agents include, but not limited to, perfume; malodor agents (e.g., uncomplexed cyclodextrin, odor blockers, reactive aldehydes, flavonoids, zeolites, activated carbon, or mixtures thereof); fabric softener actives; cationic polymers; dye transfer inhibitors; shading dyes; insect repellents; organic sunscreen actives (e.g., octylmethoxy cinnamate); antimicrobial agents (e.g., 2-hydroxy-4,2,4-trichlorodiphenylether); ester solvents (e.g., isopropyl myristate); lipids and lipid like substances (e.g. cholesterol); hydrocarbons (e.g., paraffins, petrolatum, and mineral oil); fish and vegetable oils; hydrophobic plant extracts; waxes; pigments (e.g., inorganic compounds with hydrophobically-modified surface and/or dispersed in an oil or a hydrophobic liquid); sugar-esters (e.g., sucrose polyester); silicone oils, resins and modifications thereof (e.g., linear and cyclic polydimethylsiloxanes, amino-modified, alkyl, aryl, and alkylaryl silicone oils, which preferably have a viscosity of greater than 50,000 cst); or mixtures thereof.

Preferably, the benefit agent is perfume. The particles preferably comprise from 0.1 to 30% by weight of perfume materials i.e. free perfume and/or perfume microcapsules. As is known in the art, free perfumes and perfume microcapsules provide the consumer with perfume hits at different points during the wash cycle. It is particularly preferred that the particles of the present invention comprise a combination of both free perfume and perfume microcapsules.

Preferably the particles of the present invention comprise 0.5 to 20% perfume materials, more preferably 1 to 15% perfume materials, most preferably 2 to 10% perfume materials. Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

### Free Perfumes:

The particles of the invention preferably comprise 0.1 to 15% free perfume, more preferably 0.5 to 8% of free perfume by weight of the particles.

Particularly preferred perfume components are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules:

The particles of the present invention preferably comprise 0.1 to 15% of perfume microcapsules, more preferably 0.5 to 8% of perfume microcapsules by weight of the particles. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or mixtures thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The particles of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Another preferred benefit agent may be fabric softener active. The fabric softening actives may be any material known to soften fabrics. These may be polymeric materials or compounds known to soften materials. Examples of suitable fabric softening actives include quaternary ammonium compounds, silicone polymers, polysaccharides, clays, amines, fatty esters, dispersible polyolefins, polymer latexes or mixtures thereof.

The fabric softening actives may preferably be cationic or non-ionic materials. Preferably, the fabric softening actives of the present invention are cationic materials. Suitable cationic fabric softening actives are described herein.

The preferred softening actives for use in the particles of the invention are quaternary ammonium compounds (QAC).

The QAC preferably comprises at least one chain derived from fatty acids, more preferably at least two chains derived from a fatty acid. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

A preferred class of quaternary ammonium compound are so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of quaternary ammonium compounds (QACs) suitable for use in the present invention is represented by formula (I):

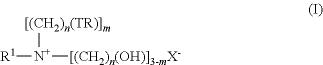

wherein each R is independently selected from a C5 to C35 alkyl or alkenyl group; R¹ represents a C₁ to C₄ alkyl, C₂ to C₄ alkenyl or a C₁ to C₄ hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

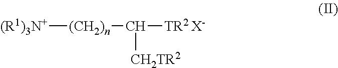

wherein each R¹ group is independently selected from C1 to C4 alkyl, hydroxyalkyl or C2 to C4 alkenyl groups; and wherein each R² group is independently selected from C8 to C28 alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

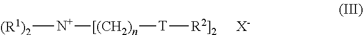

wherein each R¹ group is independently selected from C1 to C4 alkyl, or C2 to C4 alkenyl groups; and wherein each R² group is independently selected from C8 to C28 alkyl or alkenyl groups; and n, T, and X⁻ are as defined above. Preferred materials of this third group include bis(2-tallowoyloxyethyl)dimethyl ammonium chloride, partially hardened and hardened versions thereof.

A fourth group of QACs suitable for use in the invention are represented by formula (IV)

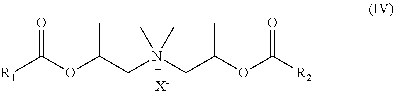

R₁ and R₂ are independently selected from C10 to C22 alkyl or alkenyl groups, preferably C14 to C20 alkyl or alkenyl groups. X⁻ is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quaternary ammonium materials present in the composition, the iodine value, referred to above, represents the mean iodine value of the parent fatty acyl compounds or fatty acids of all the quaternary ammonium materials present. Likewise, if there are any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (V):

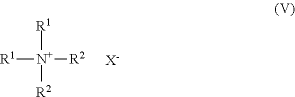

wherein each R¹ group is independently selected from C1 to C4 alkyl, hydroxyalkyl or C2 to C4 alkenyl groups; each R² group is independently selected from C8 to C28 alkyl or alkenyl groups, and X⁻ is as defined above.

The particles of the present invention preferably comprise from 0.1 to 50% by weight of the fabric softening active, more preferably from 1 to 40%, even more preferably from 5 to 35% and most preferably from 10 to 30% by weight of the fabric softening active.

### Silicates

The particles of the present invention may comprise silicates. Silicate may act as a process aid to improve the processibility of the composition in production by giving the composition hardness.

Examples of suitable silicates include, but not limited to, sodium silicate, potassium silicate, magnesium silicate, calcium silicate or mixtures thereof. Sodium silicate is particularly preferred. An example is sodium silicate commercially available from Tianjin Sailicheng Technology Co., Ltd.

Preferably the particles of the present invention comprise from 0.01 to 10% by weight of the silicates, more preferably from 0.05 to 5%, even more preferably from 0.1 to 3% and most preferably from 0.4 to 0.9% by weight of the silicates. It is not preferable to use a high level of silicates in the particles. More silicates may result in particles which are brittle and tended to break up into undesirable small pieces. Furthermore, the dissolution time of the particles in the laundry process may also be increased when a high level of silicates is present in the particles.

### Disintegrants

Preferably, the particles of the present invention comprise a disintegrant. Disintegrant, as used herein, refers to materials which are added to the particles to make them disintegrate and thus release the benefit agents upon contact with water. The particles of the present invention preferably comprise from 0.1 to 20% by weight of the disintegrant, more preferably from 0.5 to 15%, even more preferably 1 to 10%, more preferably still from 1 to 5%, and most preferably from 1.5 to 3% by weight of the disintegrant.

Preferably the disintegrant is a non-effervescent disintegrant. Examples of suitable non-effervescent disintegrant include, but not limited to, polyvinylpyrrolidone, crospovidone (cross-linked polyvinylpyrrolidone), starch derivatives, cellulose, cellulose derivatives, clays (e.g. bentonite, alginates), gums (e.g., agar, Arabic, xanthan, guar, locust bean, karaya, pectin, tragacanth), non-carbonate salt (e.g. sodium chloride, potassium chloride, magnesium sulfate, calcium silicate, magnesium aluminum silicate) or mixtures thereof.

It is preferred that the disintegrant is a cellulose or a cellulose derivative. Examples of suitable cellulose derivatives include, but not limited to, methyl cellulose, ethyl cellulose, propyl cellulose, methyl ethyl cellulose, carboxymethyl cellulose, ethyl carboxymethyl cellulose, hydroxyethyl cellulose, hydroxypropyl cellulose, carboxymethyl hydroxyethyl cellulose, methyl hydroxyethyl cellulose, hydroxypropyl methyl cellulose, ethyl hydroxyethyl cellulose, methyl ethyl hydroxyethyl cellulose, calcium carboxymethyl cellulose, sodium carboxymethyl cellulose, microcrystalline cellulose, croscarmellose sodium (cross-linked sodium carboxymethyl cellulose) or mixtures thereof. Preferably the disintegrant is selected from calcium carboxymethyl cellulose, sodium carboxymethyl cellulose, microcrystalline cellulose, croscarmellose sodium and mixtures thereof.

It is also preferred that the disintegrant is a starch derivative, which is also known as modified starch. Examples of suitable starch derivatives include, but not limited to, sodium starch glycolate, carboxymethyl starch, sodium carboxymethyl starch, hydroxypropyl starch, pre-gelatinized starch or mixtures thereof.

Preferably, the disintegrant is selected from croscarmellose sodium (cross-linked sodium carboxymethyl cellulose), sodium carboxymethyl starch, sodium starch glycolate and mixtures thereof. Croscarmellose sodium is particularly preferred. Croscarmellose sodium is particularly preferred. An example is croscarmellose sodium commercially available under Anhuisunhere Pharmaceutical Excipients Co., Ltd.

It is preferred that the particles of the present invention comprise from 0.1 to 20% by weight of croscarmellose sodium, more preferably from 0.5 to 15%, even more preferably from 1 to 10%, more preferably still from 1 to 5% and most preferably from 1.5 to 3% by weight of croscarmellose sodium.

The disintegrant may be an effervescent disintegrant. Suitable effervescent disintegrant includes a carbonate salt and an acid. Preferably the acid is selected from an organic acid, a salt of organic acid, a salt of inorganic acid and mixtures thereof. More preferably the acid is organic acids. The organic acid suitable for use in the composition of the present invention can be any organic acid. Particularly good results were achieved with organic acids being polyacids (i.e. acids having more than one carboxylic acid group), and more particularly with di- or tricarboxylic organic acids. The organic acid used in the invention has a weight average molecular mass of at most 500 Dalton, more preferably of at most 400 Dalton and most preferably of at most 300 Dalton, the molecular mass being based on the free acid equivalent. In any case, preferably the organic acid is not a polymer-based acid. The organic acid employed in accordance with the invention preferably comprises 3 to 25 carbon atoms, more preferably 4 to 15 carbon atoms.

In view of consumer acceptance and reducing environmental impact, the organic acids preferably are those which are also found naturally occurring, such as in plants. Examples of suitable organic acids include acetic acid, citric acid, aspartic acid, lactic acid, adipic acid, succinic acid, glutaric acid, gluconic acid, malic acid, tartaric acid, maleic acid, fumaric acid, saccharic acid, their salts or mixtures thereof. Of particular interest are citric acid, aspartic acid, acetic acid, lactic acid, succinic acid, glutaric acid, gluconic acid, their salts or mixtures thereof. Most preferably, the organic acid is citric acid, succinic acid, their salts or a mixture thereof.

Preferably the carbonate salt comprises sodium carbonate, sodium bicarbonate, sodium glycine carbonate, potassium carbonate, potassium bicarbonate, potassium glycine carbonate, calcium carbonate, calcium bicarbonate, magnesium carbonate or mixtures thereof. More preferably the carbonate salt comprises sodium carbonate, sodium bicarbonate, potassium carbonate, potassium bicarbonate or mixtures thereof. Most preferably the carbonate salt comprises sodium carbonate, sodium bicarbonate or mixtures thereof.

It is particularly preferred that the effervescent disintegrant is a combination of sodium bicarbonate, citric acid and succinic acid.

It is preferred that the amount of carbonate salt is related to the amount of acid. More specifically it is desired that the weight ratio of the carbonate salt to the acid is from 1:10 to 10:1, more preferably from 1:5 to 5:1, even more preferably from 1:3 to 3:1.

### Colourant

The particles of the invention may comprise a colourant. The colourant may be a dye or a pigment or a mixture thereof. The colourant has the purpose to impart colour to the particles, it is not intended to be a shading dye or to impart colour to the laundered fabrics. A single colourant or a mixture of colourants may be used.

Preferably, the colourant is a dye, more preferably a polymeric dye. Non-limiting examples of suitable dyes include the LIQUITINET range of dyes ex Milliken Chemical.

Preferably the particles of the present invention comprise 0.001 to 2%, more preferably 0.005 to 1%, most preferably 0.005 to 0.6% of by weight of the colourant.

### Water

Water may be included to enhance the processibility of the composition in production. Preferably, the particles comprise from 0.1 to 10% by weight of water, more preferably from 0.5 to 8% by weight of water, even more preferably from 1 to 6% by weight of water, and most preferably from 2% to 5% by weight of water.

### Form of Particles

The particles of the present invention may be in any solid form, for example: powder, pellet, tablet, prill, pastille or extrudate. Preferably the particles are in the form of an extruded particle.

The particles may be any shape or size suitable for dissolution in the laundry process. Preferably, each individual particle has a mass of between 0.95 mg to 5 grams, more preferably 0.005 to 1 gram, even more preferably 0.005 to 0.5 gram and most preferably 0.01 to 0.1 gram. Preferably each individual particle has a maximum linear dimension in any direction of less than 10 mm, more preferably 1 to 8 mm and most preferably of 4 to 6 mm.

It is preferred that the particles have a substantially flat base and a height perpendicular to the base. Preferably each particle has a maximum base dimension of less than 10 mm, more preferably 1 to 8 mm and most preferably of 4 to 6 mm. Preferably each particle has a height of from 0.05 to 5 mm, more preferably from 0.1 to 3 mm, and most preferably from 0.2 to 2.5 mm. It is preferred that each individual particle has a maximum base dimension of less than 10 mm and a height of from 0.05 to 5 mm.

The shape of the particles may be selected from hemispherical, compressed hemispherical, lentil-shaped, oblong, cubical, rectangular, circular, cylindrical, disc, flower-shaped, star-shaped, petal-shaped, heart-shaped and mixtures thereof. Preferably the shape of the particles is selected from disc, flower-shaped, star-shaped, petal-shaped, heart-shaped and mixtures thereof, which can be more visually attractive to consumers.

Preferably, the particles of the present invention are formed using an extrusion apparatus. The extrusion apparatus may be a single screw extruder or a twin screw extruder, preferably a twin screw extruder having co-rotating or contra-rotating screws. The present invention also relates to a method of forming the particles comprising the steps of:
(i) combining constituent ingredients of the composition to form a mixture;
(ii) feeding the mixture to an extruder and extruding it to form an extrudate;
(iii) cutting the extrudate to form the particles;
(iv) drying the particles; and
(v) optionally dusting the particles with an anti-caking agent.

Preferably, the method is carried out at a temperature from 10 to 50° C., more preferably from 15 to 40° C. and even more preferably from 20 to 30° C. It is preferred that the method is carried out at room temperature (25° C.) and one atmospheric pressure.

Preferably the mixture of step (i) is homogeneous. By homogeneous, it means that the mixture prior to extrusion has a uniform texture so that extrudates obtained from the mixture have an even quality. When the constituent ingredients of the composition include perfume microcapsules, it is preferred that the perfume microcapsules are added to the mixture as the last ingredient for mixing, which may reduce the breakage of perfume microcapsules during mixing.

During the extrusion process of steps (ii) and (iii), the mixture of step (i) is extruded from the extruder through a die having an orifice with a predetermined diameter. The extruder is equipped with a cutter-knife allowing to cut the extrudate at the die exit to form particles. The desired height of the particles may be achieved by varying the speed that the extrudate is fed into the cutter and the rate at which the extrudate is cut.

The drying step (iv) may be carried out before, during or after step (iii). Preferably the drying is carried out at room temperature (25° C.), relative humidity (RH)<50% and one atmospheric pressure, which may reduce the evaporative loss of benefit agents such as perfume.

Following step (iv), the method may comprise a step (v) of dusting the particles with an anti-caking agent. The anti-caking agent may be applied to the exterior surface of the particles to reduce the potential for particles to stick together. Examples of suitable anti-caking agent include, but not limited to, silica, zeolite, unmodified starch, cellulose, rock flour, clay, stearates of calcium and magnesium, silica, silicates, talc, flour, starch, tricalcium phosphate, powdered cellulose, sodium bicarbonate, sodium ferrocyanide, potassium ferrocyanide, calcium ferrocyanide, calcium phosphate, sodium silicate, calcium silicate, magnesium trisilicate, talcum powder, sodium aluminosilicate, potassium aluminum silicate, calcium aluminosilicate, bentonite, aluminum silicate, stearic acid, polydimethylsiloxane or mixtures thereof.

The method does not require to heat up the mixture above a melting temperature to shape it into a desired form and cool it down again, which greatly simplifies the production process and reduces the loss of benefit agents such as perfume in production.

The particles of the present invention may also be made using roller compacting. The constituent ingredients of the composition are introduced between two rollers and rolled under pressure between the two rollers to form a sheet of compactate. The sheet of compactate is broken up into small pieces by cutting. The small pieces can be further shaped into particles.

The particles of the present invention are preferably homogeneously structured. By homogeneously structured, it is meant that there is a continuous phase throughout the particle. There is not a core and shell type structure. The constituent ingredients of the particles such as the benefit agents will be distributed or dispersed within the continuous phase. When the benefit agent is perfume, it may improve the perfume stability against oxidation and evaporative loss during storage. The continuous phase is provided predominately by the carrier material.

The particles of the present invention need to dissolve in a typically wash cycle time, preferably no more than 20 minutes, more preferably no more than 15 minutes, even more preferably no more than 10 minutes. If the dissolution rate of the particles is too slow, there may be un-dissolved residues formed from constituent ingredients of the particles remaining on the laundered fabrics when the wash is complete which is undesirable for consumers. The particles preferably have a dissolution rate of no less than 1 minutes, more preferably no less than 2 minutes, and even more preferably no less than 3 minutes. If the dissolution rate of the particles is too fast, most of the benefit agents may be released early and washed away before they can be delivered to laundered fabrics to provide various benefits. Preferably the particles have a dissolution rate from 1 minutes to 20 minutes, more preferably from 2 minutes to 15 minutes, even more preferably from 3 minutes to 10 minutes.

### Method of Use

The particles of the present invention are for use in the laundry process. They may be added in the wash sub-cycle or a rinse sub-cycle of a laundry cycle using a washing machine.

Alternatively, the particles may be used in manual hand washing of fabrics. The particles may be used in addition to other laundry products or they may be used as a standalone product.

The particles of the present invention are preferably dosed in a quantity of 1 g to 50 g, more preferably 10 g to 45 g, most preferably 15 g to 40 g. The particles may be dosed by consumers from a package directly into the washing machine or into a dosing compartment on the washing machine.

The present invention also relates to a method of treating laundry comprising the steps of:
(i) providing fabrics in a washing machine;
(ii) dispensing the laundry composition into the washing machine; and
(iii) contacting the fabrics with the laundry composition during a wash sub-cycle of the washing machine.

### Use for the Particles

Typically, the primary use of the particles of the present invention is to provide fabric care benefits to laundered fabrics during the laundry process. Preferably the particles are used to impart fragrance to laundered fabrics during the laundry process.

The following examples are provided to facilitate an understanding of the invention. The examples are not intended to limit the scope of the claims.

### Examples

Particles were prepared as shown in Table 1. All ingredients are expressed by weight percent of the total formulation.

TABLE 1

| | Samples | |
|---|---|---|
| Ingredient | A | 1 |
| Sugar^{a} | 43.1 | 43.1 |
| Starch | 13 | 13 |
| Sodium chloride | 21 | 21 |
| Linear alkylbenzene | 8 | — |
| sulfonate | | |
| Sodium lauryl sulfate^{b} | — | 8 |
| Sodium silicate solution | 1 | 1 |
| (34% active)^{c} | | |
| Free perfume | 6 | 6 |
| Perfume microcapsules | 3.5 | 3.5 |
| Colourant | 0.4 | 0.4 |
| Water | To 100 | To 100 |
| Dissolution time/minutes | 14 | 9 |
| Stickiness | Easy to stick | Not easy to stick |
| Residues | Obvious residues | No visible residues |

^{a}Refined cane sugar from Guangxi Fengtang Biochemical Co., Ltd
^{b}Sodium lauryl sulfate from Dongming Jujin Chemical Co., Ltd
^{c}Sodium silicate solution (34% active) from Tianjin Sailicheng Technology Co., Ltd

### Process of Manufacturing Particles

Samples were prepared as follows: the ingredients except for the perfume microcapsules were added into a dough mixer and mixed evenly by a triple-roller miller. After that, the perfume microcapsules were added into the dough mixer and the resulted mixture was mixed evenly.

The mixture was fed into a twin-screw co-rotating extruder fitted with a die having an orifice with a predetermined diameter and cutter blade. The mixture was extruded to form an extrudate having a diameter of about 5 mm. The extrudate was cut into particles with a thickness of about 2 mm. The particles were dried at room temperature (25° C.) and one atmospheric pressure.

It has been found that the samples comprising less than 5% by weight of anionic surfactants were difficult to be extruded through the die of extruder, and the formed extrudates were brittle and tended to break up into undesirable small pieces. When the samples comprised more than 15% by weight of anionic surfactants, the extrudate became too soft and sticky which caused the extrudates to stick together, bend or swell.

It was also observed that particles of Sample A were more likely to stick together.

### Method to Test Dissolution Time

2.5 gram of each sample was dosed into 500 mL water at 25° C. under stirring at 620 rpm. The dissolution time was measured from T₀ (when the sample is dosed into 500 mL water) to T₁ (when the sample is completely dissolved and no visible solid is observed).

It can be seen in table 1 that sample 1 had a dissolution time of 9 minutes, while that of Comparative A had a longer dissolution time of 14 minutes.

### Evaluation of Residues

A 0.3 kg ballast load comprised of 1 pieces of cotton T-shirt and 2 pieces of Terry Towelling Squares (30×30 cm size). The towelling squares were mixed in with the cotton T-shirt in a random order within the washing machine so that they are not all together. 20 g of samples were added to the drum of a front-loading washing machine followed by the mixed fabrics and finally 20 g of liquid detergent (commercial OMO detergent) was added to the draw of the machine, door was closed and then the machine was set to standard wash. Wash time was 15 minutes including one-time wash and two times rinses. Once the wash had finished, photos were taken to record the residues on the laundry, the washing machine door glass and the rubber ring.

The whole washing process was repeated three times and the residues were observed and recorded. No residues were visible on the laundry, the washing machine door glass and the rubber ring after washing with Sample 1 comprising sodium lauryl sulfate. When Sample A comprising LAS was used, obvious residues were observed.

1. A laundry composition comprising a plurality of particles, wherein the particles comprises:
a) from 20 to 95% by weight of a water-soluble carrier selected from a carbohydrate, an inorganic alkali metal salt, an organic alkali metal salt, an inorganic alkaline earth metal salt, an organic alkaline earth metal salt, a urea and mixtures thereof;
b) from 5 to 12% by weight of an anionic surfactant selected from alkyl sulfate, alkyl ether sulfate, soap, and mixtures thereof; and
c) from 0.1 to 30% by weight of benefit agents;
d) from 1 to 20% by weight of benefit agents;
wherein the water-soluble carrier is selected from a carbohydrate, an inorganic alkali metal salt and mixtures thereof;
wherein the water-soluble carrier comprises sugar selected from dextrose, sucrose, fructose, glucose, isoglucose, rhamnose, fucose, deoxyribose, ribose, trehalose, xylose, mannose, arabinose, galactose, cellobiose, lactose, maltose, isomaltose, melibiose, gentobiose, maltotriose, raffinose, panose, and mixtures thereof;
wherein the particles comprise no more than 12% by weight of an anionic surfactant;
wherein the benefit agent is perfume; and wherein the composition comprises less than 1.5% by weight of alkylbenzene sulfonates.

2. The laundry composition according to claim 1, wherein the benefit agent is dispersed within the water-soluable carrier.

3. The laundry composition according to claim 1, wherein the water-soluble carrier comprises sugar selected from dextrose, sucrose, fructose, glucose, isoglucose, galactose, raffinose, and mixtures thereof.

4. The laundry composition according to claim 1, wherein the anionic surfactant is selected from alkyl sulfate, alkyl ether sulfate, and mixtures thereof.

5. The laundry composition according to claim 1, wherein the alkyl sulfate comprises sodium, potassium, calcium, magnesium, ammonium or ethanolamine salts of alkyl sulfate having 8 to 18 carbon atoms.

6. The laundry composition according to claim 1, wherein the anionic surfactant is present in an amount of from 6 to 12% by weight of the composition.

7. (canceled)

8. The laundry composition according to claim 1, wherein the benefit agent is a combination of free perfume and perfume microcapsules.

9. The laundry composition according to claim 1, wherein the particles comprise from 1 to 15% by weight of perfume.

10. The laundry composition according to claim 1, wherein the particles comprise a disintegrant selected from polyvinylpyrrolidone, crospovidone, starch, starch derivatives, cellulose, cellulose derivatives, clays, gums, non-carbonate salt and mixtures thereof.

11. The laundry composition according to claim 1, wherein each particle has a maximum linear dimension in any direction of less than 10 mm.

12. A method of forming the laundry composition according to claim 1 comprising the steps of:
(i) combining constituent ingredients of the composition to form a mixture;
(ii) feeding the mixture to an extruder and extruding the mixture to form an extrudate;
(iii) cutting the extrudate to form the particles;
(iv) drying the particles; and
(v) optionally dusting the particles with an anti-caking agent.

13. A method of treating laundry comprising the steps of:
(i) providing fabrics in a washing machine;
(ii) dispensing the laundry composition according claim 1 into the washing machine; and
(iii) contacting the fabrics with the laundry composition during a wash sub-cycle of the washing machine.

14. The method according to claim 13 wherein the laundry composition provides fabric care benefits to the fabrics, the laundry composition comprising fragrance, shading dye, malodor agent, fabric softener active, cationic polymer, dye transfer inhibitor: shading dye, insect repellent: organic sunscreen active, antimicrobial agent, plant extract wax, pigment, sugar-ester, silicone oil, resin, or a mixture thereof.
